(19) United States
(12) Patent Application Publication
(10) Pub. No.: US 2013/0315588 A1
(43) Pub. Date: Nov. 28, 2013

(54) APPLIANCE AND ARRANGEMENT FOR OPTICAL SIGNAL TRANSMISSION BY MEANS OF OPTICAL WAVE-GUIDES

(71) Applicants: Marco Ahler, Muhlheim (DE); Henner Rüschkamp, Lunen (DE); Stefan Kratochvil, Lunen (DE)

(72) Inventors: Marco Ahler, Muhlheim (DE); Henner Rüschkamp, Lunen (DE); Stefan Kratochvil, Lunen (DE)

(73) Assignee: Caterpillar Global Mining Europe GmbH

(21) Appl. No.: 13/994,022

(22) PCT Filed: Dec. 16, 2011
(86) PCT No.: PCT/IB11/55749

§ 371 Date: Jul. 22, 2013

(30) Foreign Application Priority Data
Dec. 23, 2010 (DE) 20 2010 013 212.6

(51) Int. Cl. H04B 10/25

(52) U.S. Cl. CPC H04B 10/2503
USPC 398/45; 398/200; 398/139; 398/58

(57) ABSTRACT

An appliance for optical signal transmission using optical waveguides in explosion-hazard areas, in particular in underground mining, includes an optical transmitter, having an optical output interface for connection of an optical waveguide transmission path and having a device for limiting the light power. An arrangement for bi-directional optical signal transmission is also provided. In order to provide an appliance for optical signal transmission as well as an arrangement for bi-directional optical signal transmission in explosion-hazard areas, complying with the requirements for intrinsically safe operation of the transmission medium when separating or decoupling the transmission medium, the device for limiting the light power is a passive optical component which is connected in the optical signal path between the optical transmitter and the optical output interface.

### CROSS-REFERENCE TO RELATED APPLICATIONS

This application claims the benefit of priority to international patent application number PCT/IB2011/055749, having a filing date of Dec. 16, 2011, which claims the benefit of priority to German patent application number DE202010013212.6, having a filing date of Dec. 23, 2010, the complete disclosures of which are hereby incorporated by reference for all purposes.

### TECHNICAL FIELD

The invention relates to an appliance for optical signal transmission by means of optical waveguides in explosion-hazard areas, in particular in underground mining, having an optical transmitter, having an optical output interface for connection of an optical waveguide transmission path and having a device for limiting the light power. The invention furthermore also relates to an arrangement for bi-directional optical signal transmission by means of optical waveguides in explosion-hazard areas, in particular in underground mining, having a first transmitting/receiving unit and a second transmitting/receiving unit, which is connected via an optical waveguide transmission path to the first transmitting/receiving unit, with at least one transmitting/receiving unit having an optical transmitter, an optical output interface for connection of the optical waveguide transmission path in the transmission direction, a device for limiting the light power and an optical receiver with an optical input interface for connection of the optical waveguide transmission path in the reception direction.

### BACKGROUND

Process control of complex industrial installations is dependent on network architectures which comply with the requirement to reliably connect to one another different installation parts such as controllers, sensors and actuators with sufficient transmission capacity over long distances. Optical waveguides are also known, in addition to electrical cables and radio, as a transmission medium for communication networks. An optical waveguide is insensitive to interference caused by radiated electromagnetic interference, and, because of its low attenuation, is able to transmit a signal over long distances with only minor losses. Furthermore, wide bandwidths can be transmitted via an optical waveguide transmission path, which also allows the implementation of standardized network protocols. An optical waveguide transmission path is therefore in principle also suitable for process automation for networking of installation components.

For use in an explosive atmosphere, protective measures which prevent ignition of the explosive gas mixture must in principle be provided even for communication networks. In the case of an optical transmission medium, a significant explosion risk may be linked to the direct or indirect heating of the gas atmosphere resulting from the occurrence of optical radiation. For example, a radiation output can occur if a plug connection is detached or in the event of a cable defect. Appliances or transmission media for explosive atmospheres are therefore in principle subject to particular electrical and optical safety measures. The requirements which these appliances have to comply with for explosion protection reside in international standards. Appliances for use in explosion-hazard areas must not be marketed unless they comply with the requirements stipulated in the Standard. In underground mining, the specific national safety regulations generally stipulate special licensing for the respective appliance, without which the appliance must not be used in underground mining. In practice, this means tedious certification processes and type tests for the appliance manufacturer, which are required not only for new appliances, but also apply to any modification as well as servicing and repair work on the flameproofed appliance.

The various possible ways to ensure explosion protection are documented in most internationally valid Standard series and are referred to there as types of flameproof protection. Electrical appliances for operation in explosion-hazard areas must normally be designed to comply with at least one of these types of flameproof protection, although it is sufficient for the appliances to be flameproof overall. The pressure-resistant encapsulation type of flameproof protection or the intrinsically safe type of flameproof protection are primarily used as widespread electrical protection measures. In the pressure-resistant encapsulation type of flameproof protection, parts which can ignite an explosive atmosphere are enclosed in a housing which withstands the pressure in the event of explosion of an explosive mixture in the interior, and prevents the explosion from being transmitted to the atmosphere surrounding the housing. In this case, the electrical connections are in the form of pressure-resistant, flameproof cable and line bushings. The intrinsically safe type of flameproof protection requires that the electrical appliances which are used in the explosion-hazard area contain only intrinsically safe circuits. A circuit is intrinsically safe if no spark and no thermal effect can cause the ignition of a specific explosive atmosphere in defined test conditions which take account of normal operation and specific fault conditions.

In the case of appliances having optical components, suitable measures must be taken to avoid the possibility of the optical radiation igniting an explosive atmosphere. Three measures are known for this purpose: “protected optical radiation” (Ex op pr) which, for example, can be achieved by metal sheathing of the glass fibres which form the transmission medium, “blocking optical radiation” (Ex op sh), in which blocking apparatuses interrupt the beam path in the event of a fault, and “inherently safe optical transmission” (Ex op is). The latter measure is also referred to as optical intrinsic safety and may consist of the light power which is emitted directly by the optical transmitter being limited to a maximum value which is below the limit value which is required to ignite an explosive atmosphere.

In order to limit the light power of an appliance, an LED or a laser diode may be installed as a light source in the appliance, which is intrinsically unable to produce an output power above a specific limit value. This greatly restricts the useable optical transmitters and requires an adequate stock of appropriate diodes for the manufacturer of the appliance.

Another solution is regulation of the light source such that the power which is output from the light source and is input into the optical waveguide does not exceed a predetermined maximum value. In this case, the electronic components for the regulation circuit must be adequately stocked, because the licensing for the respective appliance or appliance type remains valid only in the case of physical identity, which necessitates the use of the same parts. Furthermore, active power regulation of the optical radiation source is dependent on the regulation circuit having its own power supply, and is accordingly complex to implement.

Overall, the solutions known so far are inflexible or costly to implement, they restrict the options for use of the appliances, and cause considerable technical and financial adaptation costs.

### SUMMARY

The invention is therefore based on the object of providing an appliance for optical signal transmission as well as an arrangement for bi-directional optical signal transmission in explosion-hazard areas, by means of which the requirements for intrinsically safe operation of the transmission medium are complied with, separation or decoupling of the transmission medium connected to the appliance is allowed even in an explosion-hazard atmosphere and which also allows the appliance to be matched to different options for use or to the installation of different electronic or optoelectronic components, with little cost.

These objects are achieved by an appliance and by an arrangement where provision is made for the device for limiting the light power to be a passive optical component which is connected in the optical signal path between the optical transmitter and the optical output interface.

On the basis of the solution according to the invention, a passive optical component which limits the light power is connected between the optical transmission source (transmitter) and the optical output of the appliance. The measure according to the invention makes it possible to ensure that the transmission path downstream from the appliance is operated in an intrinsically safe manner, and at a maximum at a permissible light power, irrespective of the choice of the optical transmitter and/or of the electronic or optoelectronic components in the appliance, since the maximum light power is limited, at least at the optical output. In comparison to active power regulation, this has the advantage, inter alia, that the passive component does not require its own power supply. This in turn simplifies the circuit design of the appliance, such that it is possible to dispense with power supply units and regulation elements which are subject to faults, whilst also avoiding the development effort for reliably operating stable control loops. Because of the reduced number of discrete electrical and electronic components, it is considerably easier, if required, to design the appliance itself for the intrinsically safe type of flameproof protection.

In one advantageous refinement, the passive optical component is an attenuating element with a non-linear transmission characteristic for the light power which can be input or launched into and output from the attenuating element. The non-linear transmission characteristic makes it possible to define the light power which can be output as a function of the light power which is present at the passive optical component, such that the light power does not exceed a limit value, and such that equipment downstream therefrom can be operated intrinsically safely. In comparison to an attenuating element with a constant attenuation, in which the output light power always depends on the input power, a non-linear profile of the characteristic makes it possible to limit the light power which can be output, without further circuitry components.

It is also advantageous if the non-linear transmission characteristic has at least one attenuation area in which the light power which is input into the attenuating element is constantly attenuated, a limiting range in which the light power which can be output is limited to a maximum value, and a switch-off range, in which no light power emerges from the attenuating element. At low input powers, the operating point varies within the attenuation area, and the passive attenuating element with a non-linear characteristic acts like an attenuating element with constant attenuation; the input power is passed on to the output, attenuated by a specific factor. If the input light power exceeds a specific value, the output light power does not increase any further, but remains constant at a maximum value over a dynamic range of the input power. The output power is therefore “decoupled” from the input power in the limiting range, since the output power remains locked at a fixed value, independently of the value of the input power. If the input power rises further, the limiting/dynamic range is left, and the attenuating element interrupts the optical signal flow, analogously to an electrical fuse, with the output power level falling steeply.

The use of the passive optical attenuating element with the described non-linear transmission response as a barrier for the light power which can be output in the signal path upstream of the optical output makes it possible to modify the electronic and optoelectronic circuit components upstream of this barrier as required in an appliance which is licensed for mining since, because of the “decoupling” they have no influence on the maximum output power and therefore have no effect on the intrinsically safe operation of optical equipment connected downstream. Once a license has been granted for the appliance, subject to the precondition that at least the passive optical attenuating element with the non-linear transmission characteristic remains as a barrier in the appliance, this remains valid even in the event of modification to the circuitry located upstream of the barrier in the signal flow. This saves a repeated time-consuming and costly certification process.

The maximum value of the light power which can be output can be preset in the limiting range of the attenuating element, with the light power which can be output at the optical interface preferably being able to be limited or being limited to a maximum value of below about 150 mW, furthermore preferably below about 35 mW. These limit values comply with the ignition requirements for the maximum permissible light power for methane (150 mW) and for other combustible gases (35 mW), since no ignition occurs below these limit values.

For practical use of the appliance according to the invention, it is particularly advantageous if the optical transmitter is arranged together with an optical receiver, the optical component and circuit parts for a communication network in the interior of an appliance housing, which is provided with the optical output interface and an optical input interface for bi-directional optical data transmission. The installation of these components in a common housing results in a compact appliance which can be used in wide fields of operation for optical signal transmission by means of optical waveguides in explosion-hazard areas. The integration of circuit parts for a communication network on the one hand and the bi-directional optical interface on the other hand, in conjunction with optical waveguide transmission, allow the use of the appliance in a network assembly, which in principle can be designed as required, with optical signal transmission and possibly also cable-based or radio-based transmission. The optical transmitter and the optical receiver can particularly expediently be integrated in a network switch which allows the subdivision of the network into different segments and their connection via optical signals without further optical converters, with the passive optical component ensuring the optical ignition safety of the appliance at the optical output, and therefore the optical intrinsic safety of all downstream equipment connected to the appliance, in particular such as the transmission path.

In order to ensure data interchange between different communication points, means for implementation of a network protocol may be provided in the communication network. The use of a common Standard allows communication to be achieved even between system components from different manufacturers. The implementation of the widely used Ethernet protocol is then particularly expedient as an access method to the optical transmission medium and the further communication paths which may be provided, since this allows the use of widely used standard components.

According to one particularly preferred refinement, the housing is in the form of an encapsulation, in particular complying with the pressure-resistant encapsulation type of flameproof protection (“d”), by means of which the appliance can also comply, in terms of the installed electrical and electronic components, with the required ignition safety for use in an explosion-hazard area, and can therefore comply with the requirements for electrical ignition safety. Alternatively, the overpressure encapsulation (“p”), oil encapsulation (“o”), sand encapsulation (“q”) or potting encapsulation (“m”) types of flameproof protection could also be used. If the appliance is designed for the pressure-resistant encapsulation type of flameproof protection, all the components are enclosed in a housing which withstands the pressure in the event of the explosion of an explosive mixture in the interior, and prevents the explosion from being transmitted to the atmosphere surrounding the housing. The electrical and optical connections, in conjunction with this type of protection, are then preferably in the form of pressure-resistant and flameproof cable and line bushings.

For construction of the pressure-resistant and flameproof optical cable and line bushings (optical interface), the housing advantageously has at least one housing hole through which an adapter body is passed, which is provided on the inside and outside with optical waveguide connections and in which at least an optical waveguide is encapsulated. This ensures hermetic sealing, as a result of which any explosion taking place in the interior of the housing cannot leave the encapsulation, preventing propagation to the atmosphere surrounding the housing. If the appliance is not itself used in the explosion-hazard area, for example because it is arranged above ground, there is no need for any electrical ignition protection measures for electrical flameproofing of the appliance, and it is sufficient to ensure optical ignition safety at the output interface, therefore allowing the downstream optical transmission medium to be operated in an exclusively intrinsically safe manner.

It is self-evident that all electrical circuit arrangements could also be designed even for the intrinsically safe type of flameproof protection and/or the enhanced safety type of flameproof protection. While, in the case of the intrinsically safe type of flameproof protection, no electrically exposed lines may exceed a limit value, additional measures are taken for the enhanced safety type of flameproof protection in order to prevent the possibility of unacceptably high temperatures and the creation of sparks and arcs in the interior or on external parts of electrical equipment, in which these do not occur during normal operation, with an enhanced level of safety.

In the case of an arrangement according to the invention for bi-directional optical signal transmission by means of optical waveguides in explosion-hazard areas, it is expedient to use only appliances according to the invention with integrated, passive, optically power-limiting components upstream of the optical output since then, in principle, there is no need for any protection measures on the transmission means, and it is possible to provide a cost-effective and flexible optical communication infrastructure for use in underground mining.

In one particular refinement of the arrangement, the optical waveguides in the transmission path may consist of plastic and/or glass fibre. Because the production costs are lower than those of glass fibre and the connection techniques can be used universally, it is advantageous to use plastic fibre in particular for short transmission paths, such as those which can exist between installation components of a roller loader or of a transport vehicle as machines in an underground mining installation.

### BRIEF DESCRIPTION OF THE DRAWINGS

Further advantageous refinement features will become evident from the following description and the drawings, which explain embodiments of the invention with reference to examples. In this case, illustrated schematically:

FIG. 1 uses a block diagram to show the basic design of the transmitting path of an appliance according to the invention for optical signal transmission by means of optical waveguides,

FIG. 2 schematically illustrates a non-linear transmission characteristic of an attenuating element,

FIG. 3 schematically illustrates an appliance according to the invention having a transmitting and receiving unit complying with the pressure-resistant encapsulation type of flameproof protection, and

FIG. 4 schematically illustrates one exemplary embodiment of an arrangement according to the invention for bi-directional optical signal transmission by means of optical waveguides.

### DETAILED DESCRIPTION

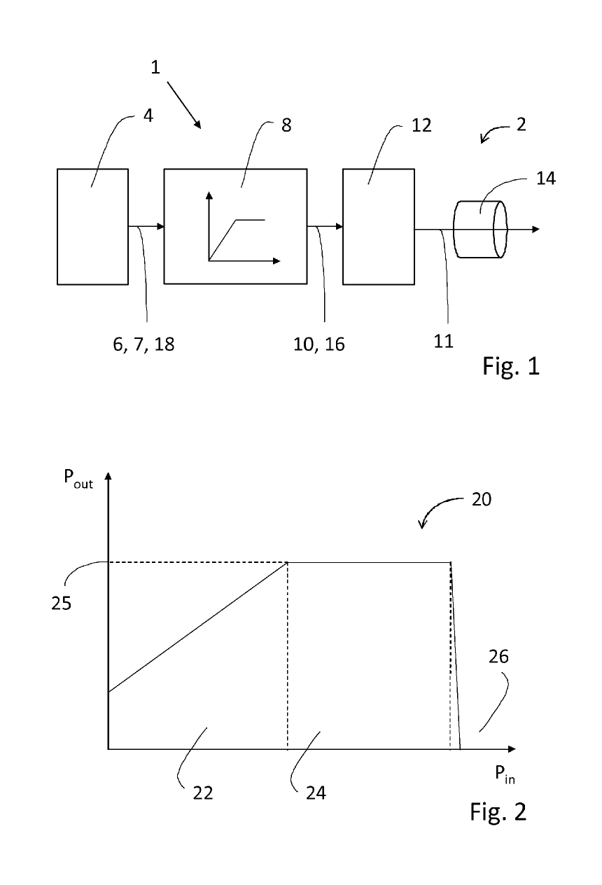

FIG. 1 uses a block diagram to show the basic functional design of the transmitting unit 1 of an appliance 2 according to the invention for optical signal transmission. The optical source signal 6 which is output from an optical transmitter 4 is supplied to a device for limiting the light power 8 as an input signal 7. Firstly, the output signal 10 from the limiting device 8 is fed via an optical output interface 12 as a transmitted signal 11 into an optical waveguide transmission path 14. The device for limiting the light power 8 is in this case always in the form of a passive optical component 8, and accordingly does not require any apparatus for supplying power, or any form of regulation devices.

The power Pₒᵤₜ 16 of the output signal 10 from the optical component 8 is described by the transmission characteristic 20 in FIG. 2, as a function of the power Pᵢₙ 18 supplied in the input signal 7. In this case, the transmission characteristic 20 has a non-linear profile with three ranges. In an attenuation area 22, the passive optical component acts as a constant attenuating element, and the light power Pᵢₙ 18 supplied is made available, attenuated by a specific factor, as the output power Pₒᵤₜ 16 at the output of the attenuating element 8. If the input power Pᵢₙ 18 increases further, a limiting range 24 is entered, which is characterized in that the output power Pₒᵤₜ 16 assumes a constant maximum value 25, irrespective of the further increase in the input power Pᵢₙ 18. The width of this limiting range 24 with respect to the input signal 7 or the input power Pᵢₙ 18 can also be regarded as a range which allows a statement to be made relating to the bandwidth within which the input power Pᵢₙ 18 may fluctuate, with the output power Pₒᵤₜ 16 remaining constant. Any increase in the input power Pᵢₙ 18 beyond the limiting range 24 leads in a switch-off range 26 to a steep drop in the output power Pₒᵤₜ 16, comparable to the blowing of an electrical fuse. It is self-evident that the illustrated characteristic is only an example, and the actual profile of the transmission characteristic may vary.

The passive attenuating element 8 which is connected in-between upstream of the optical output 12 and is arranged in series with the optical transmitter 4 therefore protects all the downstream equipment, initially reversibly, in the limiting range 24, and then irreversibly in the switch-off range, against unacceptably high light power levels. Intrinsically safe operation of the optical waveguide transmission path 14 which is coupled to the optical output interface is therefore always ensured, even if, for example, a different optical transmitting element were to be installed in the appliance 2.

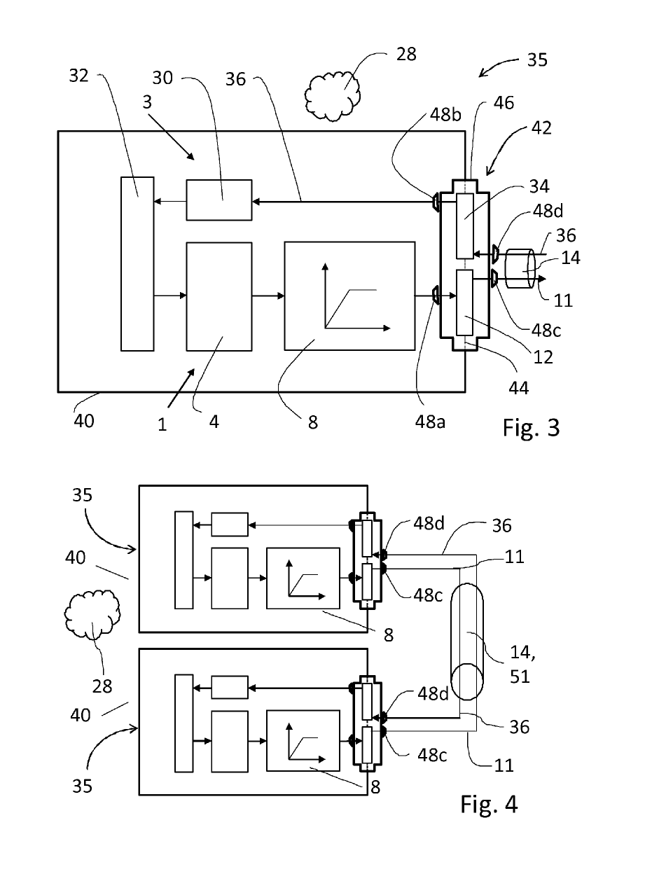

FIG. 3 shows an appliance which is annotated overall with the reference symbol 35, with a transmitting unit 1 which includes the passive attenuating element 8 and, additionally with a receiving unit 3 for bi-directional data transmission by means of optical waveguides with the pressure-resistant encapsulation type of flameproof protection. The pressure-resistant encapsulation version is in this case provided by the schematically illustrated pressure-resistant housing 40 together with a pressure-resistant, flameproof optical line bushing 42. Because of the pressure-resistant encapsulation type of flameproof protection and the attenuating element 8, the appliance 35 can be operated directly in an explosion-hazard area 28, irrespective of the rest of the design and configuration of the transmitting and receiving unit 1, 3. The schematic illustration in FIG. 3 forms a link between a functional block diagram and a schematic sketch of the design of the appliance 35. In addition to the optical transmitter 4, the limiting device 8 and the optical output interface 12, an optical receiver 30 and circuit parts for a communication network 32 are shown, as well as an optical input interface 34. In the receiving direction, a signal 36 which is received by means of the optical waveguide transmission path 14 which can be detachably coupled to the appliance is passed via the optical input interface 34 to the optical receiver 30. In conjunction with those components of the transmitting unit 1 which are arranged in the transmitting direction, in this case together with the optical transmitter 4, the limiting device 8 and the optical output interface 12, the appliance 35 therefore has a transmitting unit 1 and, furthermore, a receiving unit 3 for bi-directional data interchange. The link between the optical transmitting and receiving unit 1, 3 and the circuit parts for a communication network 32 allows a wide range of interchange of data with other networks, both optically and, for example, by radio or electrical data cable (not illustrated). Furthermore, further electrical or optical interfaces, which are not illustrated here, may be provided for integration in superordinate network levels, which must then be passed out of and passed into the appliance via further bushings, which are not illustrated.

In the illustrated exemplary embodiment, the optical line supply 42 consists of an adapter body 46, which is attached to a hole 44 or cut-out in the housing 40. In this case, in each case two optical waveguide connections 48a, 48b, 48c and 48d are mounted on the inside and outside on the adapter body 46, as indicated schematically, of which in each case one connecting pair 48a, 48c carries the transmission signal 11, and the respective other connecting pair 48b, 48d carries the received signal 36. Those connections 48c, 48d which are in each case on the outside with respect to the housing 40 are used for detachable coupling of the optical waveguide transmission path 14. The outside connections 48c, 48d for connection of the optical waveguide transmission path 14 may be in the form of an industrially manufactured optical waveguide appliance socket, which is inserted, preferably in a pressure-resistant manner, into the adapter body 46. In the illustrated exemplary embodiment, an optical waveguide section is arranged within the adapter body 46, both for the optical output 12 and for the optical input 34, between the internal and external optical waveguide connections 48a, 48c for the output and 48d and 48b for the optical input, which optical waveguide section is encapsulated in the adapter 46 in order in this way to achieve pressure-resistant sealing with respect to the explosion-hazard area outside the pressure-resistant housing 40.

In the illustrated exemplary embodiment, the attenuating element 8 is connected in the optical path between the optical transmitter 4 and the output 12 over short optical waveguide sections. The attenuating element 8 could also be plugged directly onto the connection 48a, which carries the transmission signal 11, within the housing 40, or directly onto the optical transmitter 4. The attenuating element could also be integrated directly in the adapter 46, and could then be connected to the optical output 12 of the appliance 35 such that it cannot be manipulated. In order to connect further or other appliance components, in particular further signal transmission paths or power supply appliances, the pressure-resistant housing 40 may be equipped with more than one line supply 42, in which case it is also possible to pass electrical conductors or further optical conductors through the adapter body 46.

FIG. 4 shows one possible arrangement according to the invention for bi-directional optical signal transmission by means of optical waveguides in the explosion-hazard area having two appliances 35 of identical design, as shown in FIG. 3. In this arrangement, the respective external optical waveguide connection 48c (transmission signal 11) of one appliance 35 is alternately connected to the external optical waveguide connection 48d (received signal 36) of the other appliance 35 via the optical waveguide transmission path 14. This arrangement shows the exclusively intrinsically safe operation of the entire bi-directional optical waveguide transmission path 14 for each transmission direction, because the optical signal which in each case leaves the appliance always has a light intensity which is reduced by the passive, optical attenuating element 8, and which is below the potentially hazardous light energy. There can therefore be no risk of explosion even if the optical waveguide path 14 is disconnected.

The illustration in FIG. 4 relates to an application in which both appliances 35 and the optical waveguide transmission path 14 are arranged in the explosion-hazard area 28, for which reason the housings 40 of both appliances must in this case comply with the pressure-resisting encapsulation type of flameproof protection (or some other flameproof protection), in order that the electrical parts of the appliances themselves cannot produce any explosion in the explosion-hazard environment in the event of a fault, thus allowing the appliance to be operated in an electrically flameproof manner for the environment. In contrast, the optical waveguide transmission path 14, which is indicated schematically here as a two-core optical waveguide 51 (FIG. 4), may be designed as required and its technical design need not comply with any type of flameproof protection, because it is operating in an intrinsically safe manner in any case. If one of the appliances 35 is not positioned in the explosion-hazard area, for example above ground in a longwall control centre, then all that will be necessary would be to ensure that the light power is limited from the limit from the safe to explosion-hazard area. This is always done when each appliance is provided upstream of its optical output with the optical attenuating element with a suitable characteristic.

The invention is not restricted to the exemplary embodiments described, but various modifications or additions may be made which are intended to be within the scope of protection of the attached claims. By way of example, the transmitter and the receiver may be in the form of an appliance part.

1-19. (canceled)

20. An appliance for optical signal transmission using optical waveguides in explosion-hazard areas, in particular in underground mining, comprising:
an optical transmitter having an optical output interface for connection of an optical waveguide transmission path; and
a device for limiting a light power, comprising is a passive optical component which is connected in an optical signal path between the optical transmitter and the optical output interface.

21. The appliance according to claim 20, wherein the passive optical component is an attenuating element with a non-linear transmission characteristic for the light power being launchable into and outputable from the attenuating element.

22. The appliance according to claim 21, wherein the non-linear transmission characteristic has at least one attenuation area in which the light power being launched into the attenuating element is constantly attenuated, a limiting range in which outputable light power is limited to a constant maximum value, and a switch-off range, in which no light power emerges from the attenuating element.

23. The appliance according to claim 22, wherein a maximum value of the light power being outputable is preset in a limiting range of the attenuating element.

24. The appliance according to claim 20, wherein the light power being outputable at the optical interface is limitable or is limited by the optical component to a maximum value of below about 150 mW, preferably below about 35 mW.

25. The appliance according to claim 20, wherein the optical transmitter is arranged together with an optical receiver, the optical component and circuit parts for a communication network in the interior of an appliance housing, which is provided with the optical output interface and an optical input interface for bi-directional data transmission.

26. the appliance according to claim 25, wherein the optical transmitter and the optical receiver are integrated in a network switch.

27. The appliance according to claim 25, wherein the communication network is configured to implement a network protocol.

28. The appliance according to claim 27, wherein the network protocol is an Ethernet protocol.

29. The appliance according to claim 25, wherein the appliance housing is in the form of an encapsulation, by which the appliance complies with a standardized type of flameproof protection.

30. The appliance according to claim 29, wherein the appliance housing is embodied in a pressure-resistant encapsulation type of flameproof protection, with the appliance housing preferably being provided with an optical pressure-resistant and flameproof line bushing.

31. The appliance according to claim 30, wherein the appliance housing has a housing hole in which an adapter body is arranged, which is provided on the inside and outside with pairs of optical waveguide connections, with an optical waveguide which is encapsulated in the adapter body being arranged between each pair of optical waveguide connections.

32. The appliance according to claim 25, wherein the optical attenuating element is plugged into or mounted in the optical output on the inside of the appliance housing, or is a component of the optical output.

33. An arrangement for bi-directional optical signal transmission using optical waveguides in explosion-hazard areas, in particular in underground mining, comprising:
a first transmitting/receiving unit and a second transmitting/receiving unit, the second transmitting/receiving unit coupled via an optical waveguide transmission path to the first transmitting/receiving unit;
at least one of the transmitting/receiving units having an optical transmitter, an optical output interface for connection of the optical waveguide transmission path in a transmission direction,
a device for limiting a light power; and
an optical receiver with an optical input interface for connection of the optical waveguide transmission path in a reception direction;
wherein the device for limiting the light power is a passive optical component which is connected in the optical signal path between the optical transmitter and the optical output interface.

34. The arrangement according to claim 33, wherein the passive optical component is an attenuating element with a non-linear transmission characteristic for the light power being feedable into and outputable from the attenuating element.

35. The arrangement according to claim 34, wherein the non-linear transmission characteristic has at least one attenuation area in which the light power which is input into the attenuating element is constantly attenuated, a limiting range in which the outputable light power remains limited to a constant maximum value, and a switch-off range, in which no light power emerges from the attenuating element.

36. The arrangement according to claim 33, wherein the optical transmitter is arranged together with the optical receiver, the optical component and circuit parts for a communication network in the interior of an appliance housing, which is provided with the optical output interface and an optical input interface for bi-directional data transmission.

37. The arrangement according to claim 33, wherein the optical waveguides in the transmission path comprise plastic and/or glass fibre.
